(19) United States
(12) Patent Application Publication
(10) Pub. No.: US 2003/0001908 A1
(43) Pub. Date: Jan. 2, 2003

(54) Picture-in-picture repositioning and/or resizing based on speech and gesture control

(75) Inventor: Eric Cohen-solal, Ossining, NY (US)

Correspondence Address: Corporate Patent Counsel;, U.S. Philips Corporation, 580 White Plains Road, Tarrytown, NY, 10591, US

(73) Assignee: Koninklijke Philips Electronics N.V.

(21) Appl. No.: 09/896,199

(22) Filed: Jun. 29, 2001

(51) Int. Cl. G09G 5/00

(52) U.S. Cl. 345/863

(57) ABSTRACT

A video display device having a picture-in-picture (PIP) display, an audio input device, an image input device, and a processor. The device utilizes a combination of an audio indication and a related gesture from a user to control PIP display characteristics such as a position of the PIP within a display and the size of the PIP. A microphone captures the audio indication and the processor performs a recognition act to determine that a PIP control command is intended from the user. Thereafter, the camera captures an image or a series of images of the user including at least some portion of the user containing a gesture. The processor then identifies the gesture and affects a PIP display characteristic in response to the combined audio indication and gesture.

### FIELD OF THE INVENTION

This invention generally relates to a method and device to enhance home television usage. Specifically, the present invention relates to a picture-in-picture display (PIP) that may be repositioned and/or resized.

### BACKGROUND OF THE INVENTION

It is very common for televisions to have a capability of displaying more than one video display on the television display at the same time. Typically, the display is separated into two or more portions wherein a main portion of the display is dedicated to a first video data stream (e.g., a given television channel). A second video data stream is simultaneously shown in a display box that is shown as an inset over the display of the first data stream. This inset box is typically denoted as a picture-in-picture display (“PIP”). This PIP provides the functionality for a television viewer to monitor two or more video data streams at the same time. This may be desirable for instance at a time when a commercial segment has started on a given television channel and a viewer wishes to “surf” additional selected television channels during the commercial segment, yet does not wish to miss a return from the commercial segment. At other times, a viewer may wish to search for other video content or just view the other content without missing content on another selected channel.

In any event, PIP has a problem in that the PIP is typically shown in an inset box that is overlaid on top of a primary display. The overlaid PIP has the undesirable effect of obscuring a portion of the primary display.

In prior art systems, the PIP may be resized utilizing a remote control input so that the user may decide what size to make the PIP to avoid obscuring portions of the underlying video images. In other systems, a user may utilize the remote control to move the PIP to pre-selected or variably selectable portions of the video screen. However, these systems are unwieldy and confusing for a user to operate.

In some systems, it is shown that a television may be responsive to voice control to control television functions such as channel selection and volume control. However, these systems have problems in that users are not familiar with voice control and the voice recognition systems have problems in discerning between different control features. In addition, oftentimes there may be voice signals that are not intended as control commands.

In the art of computer vision there are known systems that respond to gestures of a user to control features of a given system but again these systems are difficult to manipulate and may erroneously detect gestures by users that may not be intended as a control gesture.

Accordingly, it is an object of the present invention to overcome the disadvantages of the prior art.

### SUMMARY OF THE INVENTION

The present invention is a system having a video display device, such as a television, with a picture-in-picture (PIP) display and a processor. The system further has both an audio input device, such as a microphone, and a video input device, such as a camera for operation in accordance with the present invention.

The system utilizes a combination of an audio indication and a related gesture from a user to control PIP display characteristics such as a position of the PIP within the display and the size of the PIP. The microphone captures the audio indication and the processor performs a recognition act to determine that a PIP control command is intended from the user. Thereafter, the camera captures an image or a series of images of the user including at least some portion of the user containing a gesture. The processor then identifies the gesture and affects a PIP display characteristic in response to the combined audio indication and gesture.

### BRIEF DESCRIPTION OF THE DRAWINGS

The following are descriptions of embodiments of the present invention that when taken in conjunction with the following drawings will demonstrate the above noted features and advantages, as well as further ones. It should be expressly understood that the drawings are included for illustrative purposes and do not represent the scope of the present invention that is defined by the appended claims. The invention is best understood in conjunction with the accompanying drawings in which:

FIG. 1 shows an illustrative system in accordance with an embodiment of the present invention;

FIG. 2 shows a flow diagram illustrating an operation in accordance with an embodiment of the present invention; and

FIG. 3 shows a flow diagram illustrating a setup procedure that may be utilized in accordance with an embodiment of the present invention for training the system to recognize audio indications and/or gestures.

### DETAILED DESCRIPTION OF THE INVENTION

In the discussion to follow, certain terms will be illustratively discussed in regard to specific embodiments or systems to facilitate the discussion. As would be readily apparent to a person of ordinary skill in the art, these terms should be understood to encompass other similar known terms wherein the present invention may be readily applied.

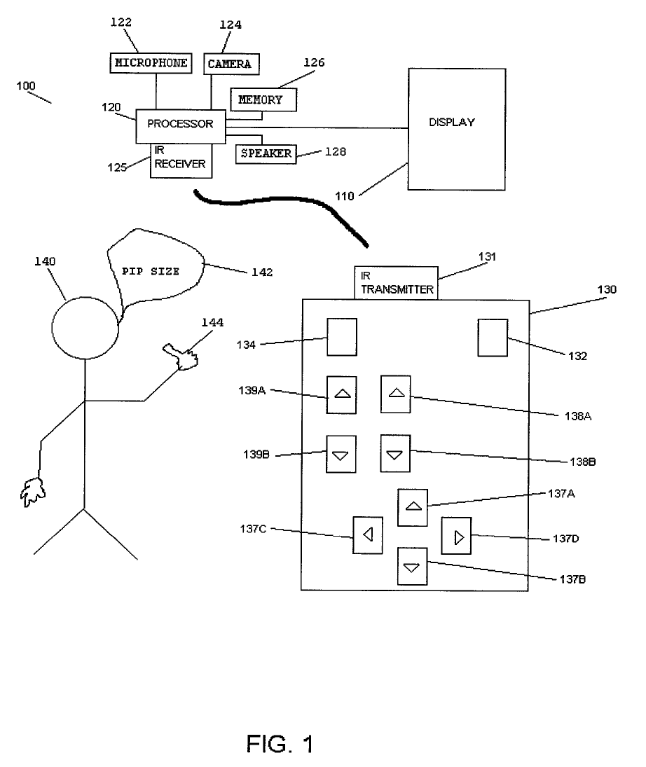

FIG. 1 shows an illustrative system 100 in accordance with an embodiment of the present invention including a display 110, operatively coupled to a processor 120, and a remote control device 130. The processor 120 and the remote control device 130 are operatively coupled as is known in the art via an infrared (IR) receiver 125, operatively coupled to the processor 120, and an IR transmitter 131, operatively coupled to the remote control device 130.

The display 110 may be a television receiver or other device enabled to reproduce audiovisual content for a user to view and listen to. The processor 120 is operable to produce a picture-in-picture display (PIP) on the display 110 as is known by a person of ordinary skill in the art. Further, the processor 120 is operable to provide, position, and size a PIP display in accordance with the present invention.

The remote control device 130 contains buttons that operate as is known in the art. Specifically, the remote control device 130 contains a PIP button 134, a swap button 132, and PIP position control buttons 137A, 137B, 137C, 137D. The PIP button 134 may be utilized to initiate a PIP function to open a PIP on the display 110. The swap button 132 swaps each of a PIP image and a primary display image which may be shown on the display 110. The PIP position control buttons 137A, 137B, 137C, 137D enable a user to manually reposition the PIP over selectable portions of the display 110. The remote control 130 may also contain other control buttons, as is known in the art, such as channel selector keys 139A, 139B and 138A, 138B for selecting the video data streams respectively for the PIP and a primary display image.

As would be obvious to a person of ordinary skill in the art, although the buttons 138A, 138B, 139A, 139B are illustratively shown as channel selector buttons, the buttons 138A, 138B, 139A, 139B may also select from amongst a plurality of video data streams from one or more other sources of video. For instance, one source of either video data stream (e.g., the PIP and the primary display image) may be a broadcast video data stream while another source may be a storage device. The storage device may be a tape storage device (e.g., VHS analog tape), a digital storage device such as a hard drive, an optical storage device, etc., or any other type of known device for storing a video data stream. In fact, any source of a video data stream for either of the PIP and the primary display image may be utilized in accordance with the present invention without deviating from the scope of the present invention.

However, as stated above, the remote control device is confusing and difficult to utilize for manipulation of the PIP. In addition, oftentimes, the PIP needs to be manipulated, such as resized or moved, in response to changes in the primary display image. For example, the area of interest in the primary display image may change as transitions in scenes of the primary display image occur.

In accordance with the present invention, to facilitate manipulation of the PIP and more specifically, a display characteristic of the PIP (e.g., size, position, etc.), the processor is also operatively coupled to an audio input device, such as a microphone 122 and an image input device, such as a camera 124. The microphone 122 and the camera 124 are respectively utilized to capture audio indications and related gestures from a user 140 to facilitate control of the PIP.

Specifically, in accordance with the present invention, a combination of an audio indication 142 followed by a related gesture 144 are utilized by the system 100 to control the PIP. This series of the audio indication 142 followed by the gesture 144 may also be utilized to activate (e.g., turn on) the PIP. The audio indication 142 and the gesture 144 are related such that the system 100 can distinguish between audio indications and gestures of a user that are not intended for PIP control. Specifically, this combination of the audio indication 142 followed by the gesture 144 helps prevent false activation of the system 100 in response to spurious background audio and gesture indications that may occur due to the users activity in and around the area where the system 100 is located.

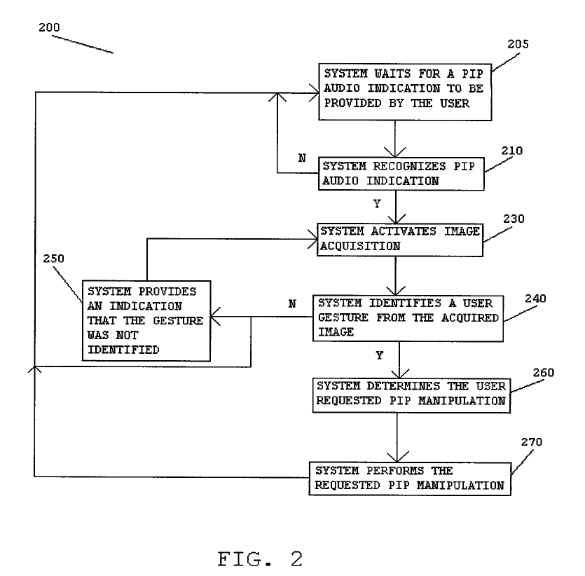

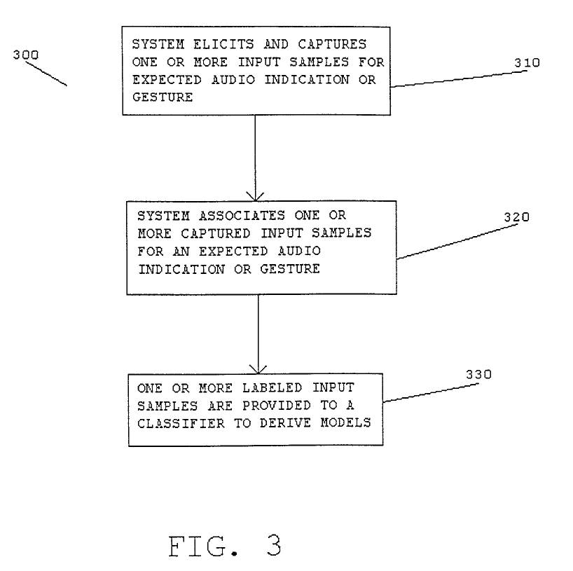

Further, the audio indication 142 and the gesture 144 are related such that the system 100 may distinguish between PIP size and position related commands. Specifically, a given gesture may be related to two or more different audio indications. For example, an audio indication of “PIP SIZE” followed by a “THUMBS UP” gesture may be utilized by a user to increase the size of the PIP. However, an audio indication of “PIP POSITION” followed by a “THUMBS UP” gesture may be utilized to reposition the PIP in an upward direction. Further operation of the present invention will be described herein with regard to FIGS. 2 and 3. FIG. 2 shows a flow diagram 200 in accordance with an embodiment of the present invention. As illustrated in the flow diagram in FIG. 2, during act 205, the user 140 provides the audio indication 142 to the system 100 and specifically, to the microphone input 122. The audio indication indicates to the system 100 that a PIP related command is intended by the user and specifically, indicates which PIP manipulation is desired. The system 100 will continue to receive and interpret audio input until a recognized audio indication is received. By the term recognized, what is intended is that the system 100 must receive an audio indication that is known by the system 100 to be related to PIP display characteristic manipulations.

The audio indication 142 may be a simple one-word term such as an utterance of “PIP” by the user 140 to simply indicate that a PIP related gesture 144 would follow. As stated above, the combinations of audio indications and gestures are related such that for a given audio indication, one or more following gestures are expected by the system 100. In the case of a simple audio indication such as “PIP”, a following gesture should indicate to the system the PIP related manipulation expected. For example, a finger (e.g., thumb) indication pointing up, down, left, right, diagonal, etc. may be a gesture to indicate a desired position for the PIP.

This combination of an audio indication followed by a related gesture may also turn on a PIP that has not previously been turned on by a separate audio indication and related gesture, or by the remote control 130. Other gestures may be utilized to indicate that a PIP size related command is intended such as two fingers held close together to indicate a desire to reduce the size of the PIP, etc. The user may utilize two fingers held far apart to indicate a desire to increase the size of the PIP.

It should be understood that the above examples of audio indications and gestures are presented merely to facilitate the explanation of the operation of the present invention and should not be considered limitations thereto. Many combinations of audio indications and corresponding gestures would be readily apparent to a person of ordinary skill in the art. Accordingly, the above examples should not be understood to limite the scope of the appended claims.

The audio indication may also be more complex multiple word utterances, such “PIP SIZE” that indicates to the system 100 that the following related gesture is intended as a command to change the PIP sizing. In any event, in act 210 the processor 120 tries to recognize the audio indication as a PIP related audio indication. This recognition act in addition to a gesture recognition act will be further described below. In the event wherein the audio indication is not recognized as a PIP related audio indication, then as shown in FIG. 2, the processor 120 returns to act 205 and continues to monitor audio indications until a PIP related audio indication is recognized.

When an audio indication is recognized by the system 100, then during act 230 the processor 120 may acquire an image or a sequence of images of the user 140 through use of the camera 124. There are known systems for acquiring and recognizing a gesture of a user. For example, a publication entitled “Vision-Based Gesture Recognition: A Review” by Ying Wu and Thomas S. Huang, from Proceedings of International Gesture Workshop 1999 on Gesture-Based Communication in Human Computer Interaction, describes a use of gestures for control functions. This article is incorporated herein by reference as if set forth in its entirety herein.

In general, there are two general types of systems for recognizing a gesture. In one system, generally referred to as hand posture recognition, the camera 124 may acquire one image or a sequence of a few images to determine an intended gesture by the user. This type of system generally makes a static assessment of a gesture by a user. In another known system, the camera 124 may acquire a sequence of images to dynamically determine a gesture. This type of recognition system is generally referred to as dynamic/temporal gesture recognition. In some systems, dynamic gesture recognition is performed by analyzing the trajectory of the hand and thereafter comparing this trajectory to learned models of trajectories corresponding to specific gestures. A general overview of the process of learning gestures and audio indications will be discussed further herein below with references to FIG. 3.

As should be clear to a person of ordinary skill in the art, there are many known ways of training systems to recognize speech. There are also many known ways for training a system to recognize gestures, both statically and dynamically. The below discussion is presented herein merely for illustrative purposes. Accordingly, the present invention should be understood to encompass these other known systems.

In any event, after the camera 124 acquires an image or a sequence of images, during act 240, the processor 120 tries to identify the gesture. When the processor 120 does not identify the gesture, the processor returns to act 230 to acquire an additional image or sequence of images of the user 140. After a predetermined number of attempts at determining a known gesture from the image or sequence of images without a known gesture being recognized, the processor 120 may during act 250 provide an indication to the user 140 that the gesture was not recognized. This indication may be in the form of an audio signal from a speaker 128 or may be a visual signal from the display 110. In this or other embodiments, after a number of tries, the system may return to act 205 to await an other audio indication.

When the processor 120 identifies the gesture, during act 260 the processor 120 determines a requested PIP manipulation by querying a memory 126. The memory 126 may be configured as a look-up table that stores gestures that the system 100 may recognize along with corresponding PIP manipulations. During act 270, after the requested PIP manipulation is retrieved from the memory 126, the processor 120 performs the requested PIP manipulation. The system then returns to act 205 to await a further audio indication from the user 140.

FIG. 3 shows an illustrative flow diagram of acts that may be utilized in training the system 100 to recognize speech and gesture inputs. Although the specific systems, algorithms, etc. for recognizing speech and voice are very different, the general acts are somewhat similar. Specifically, in act 310 the speech or gesture training system elicits and captures one or more input samples for each expected audio indication or recognizable gesture. What is intended by the term “elicits” is that the system prompts the user to provide a particular input sample.

Thereafter, in act 320, the system associates the one or more captured input samples for each expected audio indication or recognizable gesture with a label identifying the one or more input samples. In act, 330, the one or more labeled input samples are provided to a classifier (e.g., processor 120) to derive models that are then utilized for recognizing user indications.

In one embodiment, this training may be performed directly by the system 100 interacting with a user during a setup procedure. In another embodiment, this training may by performed generally once for a group of systems and the results of the training (e.g., the models derived therefrom) may be stored in the memory 126. In yet another embodiment, the group of systems may be trained once with the results stored in the memory 126, and thereafter, each system may elicit further input/training from the user to refine the models.

Finally, the above-discussion is intended to be merely illustrative of the present invention. Numerous alternative embodiments may be devised by those having ordinary skill in the art without departing from the spirit and scope of the following claims. For example, although the processor 120 is shown separate from the display 110, clearly both may be combined in a single display device such as a television. In addition, the processor may be a dedicated processor for performing in accordance with the present invention or may be a general purpose processor wherein only one of many functions operate for performing in accordance with the present invention. In addition, the processor may operate utilizing a program portion, multiple program segments, or may be a hardware device utilizing a dedicated or multi-purpose integrated circuit.

Also, although the invention is described above with regard to a PIP on a television display, the present invention may be suitably utilized with any display device that has the ability to display a primary image and a PIP including a computer monitor or any other known display device.

Numerous alternative embodiments may be devised by those having ordinary skill in the art without departing from the spirit and scope of the following claims. In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope; and

d) several “means” may be represented by the same item or hardware or software implemented structure or function.

The claimed invention is:

1. A video display device comprising:
a display configured to display a primary image and a picture-in-picture image (PIP) overlaying the primary image;
a processor operatively coupled to the display and configured to receive a first video data stream for the primary image, to receive a second video data stream for the PIP, and to change a PIP display characteristic in response to a received audio indication and a related gesture from a user.

2. The video display device of claim 1, wherein the PIP display characteristic is at least one of a position of the PIP on the display and a display size of the PIP.

3. The video display device of claim 1, comprising:
a microphone for receiving the audio indication from the user; and
a camera for acquiring an image of the user containing the related gesture.

4. The video display device of claim 1 wherein the processor is configured to analyze audio information received from the user to identify when a PIP related audio indication is intended by the user.

5. The video display device of claim 1, wherein the processor is configured to analyze image information received from the user after the audio indication is received to identify the change in the PIP display characteristic that is expressed by the received gesture.

6. The video display device of claim 5, wherein the image information is contained in a sequence of images and wherein the processor is configured to analyze the sequence of images to determine the received gesture.

7. The video display device of claim 1, wherein the image information is contained in a sequence of images and wherein the processor is configured to determine the received gesture by analyzing the sequence of images and determining a trajectory of a hand of the user.

8. The video display device of claim 1, wherein the processor is configured to determine the received gesture by analyzing an image of the user and determining a posture of a hand of the user.

9. The video display device of claim 1, wherein the video display device is a television.

10. The video display device of claim 1, wherein the image is a sequence of images of the user containing the user gesture, the video display device comprising a camera for acquiring the sequence of images of the user.

11. A method of controlling a display characteristic of a picture-in-picture display (PIP) overlaying a primary display, the method comprising:
receiving an audio indication from a user;
determining whether the received audio indication is one of a plurality of expected audio indications;
analyzing a gesture of the user if the received audio indication is one of the plurality of expected audio indications; and
controlling the display characteristic if the gesture is a gesture related to the received audio indication.

12. The method of claim 11, wherein analyzing the gesture comprises:
receiving a sequence of images; and
analyzing the sequence of images to determine the gesture.

13. The method of claim 11, wherein analyzing the gesture comprises:
receiving a sequence of images;
analyzing the sequence of images to determine a trajectory of a hand of the user; and
determining the gesture by the determined trajectory.

14. The method of claim 11, wherein analyzing the gesture comprises:
analyzing an image of the user to determine a posture of a hand of the user; and
determining the gesture by the determined posture.

15. A program segment stored on a processor readable medium for controlling a display characteristic of a picture-in-picture display (PIP) overlaying a primary display, the program segment comprising:
a program segment for controlling receipt of an audio indication;
a program segment for determining whether a received audio indication is one of a plurality of stored audio indications;
a program segment for analyzing a gesture of the user if the received audio indication is one of the plurality of stored audio indications; and
a program segment for controlling the display characteristic if the gesture is a gesture related to the received audio indication.

16. The program segment of claim 15, wherein the program segment for analyzing the gesture comprises:
a program segment for controlling receipt of a sequence of images; and
a program segment for analyzing the sequence of images to determine the gesture.

17. The program segment of claim 15, wherein the program segment for analyzing the gesture comprises:
a program segment for controlling receipt of a sequence of images;
a program segment for analyzing the sequence of images to determine a trajectory of a hand of the user; and
a program segment for determining the gesture by the determined trajectory.

18. The program segment of claim 15, wherein the program segment for analyzing the gesture comprises:
a program segment for analyzing an image of the user to determine a posture of a hand of the user; and
a program segment for determining the gesture by the determined posture.
